(19) United States
(12) Patent Application Publication
(10) Pub. No.: US 2004/0247143 A1
(43) Pub. Date: Dec. 9, 2004

(54) Device for listening to voice and/or musical signals by means of cranial bone transmission

(75) Inventors: Jean-Francois Lantrua, Hyeres (FR); Patrick Bauguil, Saint Loup Cammas (FR); Nicole Bauguil, Saint Loup Cammas (FR); Adrien Bauguil, Saint Loup Cammas (FR)

Correspondence Address: YOUNG & THOMPSON, 745 SOUTH 23RD STREET, 2ND FLOOR, ARLINGTON, VA, 22202, US

(73) Assignee: AMPHICOM, Montgiscard (FR)

(21) Appl. No.: 10/491,344

(22) PCT Filed: Sep. 27, 2002
(86) PCT No.: PCT/FR02/03311

(30) Foreign Application Priority Data
Oct. 1, 2001 (FR) 01/12600

(51) Int. Cl. H04R 25/00

(52) U.S. Cl. 381/151; 381/190; 381/173

(57) ABSTRACT

The invention relates to a device for listening to voice and/or musical signals by means of cranial bone transmission, comprising a case (8, 15) having a forward frontal face, which is sealed by a flexible membrane (11), and a rear frontal face (15a), which consists of a rigid, hermetic wall, and comprising a piezoelectric element (1) having suitable dimensions in order for same to be integrated in the case, means (18) for supporting the piezoelectric element which are suitable for joining the periphery of the latter to the case in a solid manner, in such a way as to divide the internal volume of the said case into two hermetic chambers: a forward chamber (6) filled with an incompressible gel or fluid, and a rear chamber (7) comprising damping means (28) suitable for compensating the stresses exerted on the piezoelectric element (1) which result from the forces exerted on the flexible membrane (11).

The invention relates to a device for listening to voice and/or musical signals by means of cranial bone transmission.

At the present time, the devices for listening to voice and/or musical signals usually consist of internal earphones, i.e., earphones with small-dimension end pieces which are inserted in the auditory canal. The first disadvantage of such earphones is that their regular use results in a deterioration of the auditory faculties, a phenomenon that is medically established more and more frequently, particularly in the case of users of audio cassette recorders and/or portable radios, known as personal stereos, and which can result in irreversible lesions.

Moreover, such earphones restrict the perception of external sounds, and wearing them may prove extremely dangerous in numerous situations due to the auditory isolation of their user.

At the present time, there are also listening devices in which the auditory transmission is effected by means of the process of bone conduction. Such devices, in particular, described in the patents U.S. Pat. No. 4,309,575, GB 672.722 and U.S. Pat. No. 3,134,861, which consist of electromagnetic transducers, are used principally in the medical domain for the purpose of performing audiometric tests. However, due to their design and, in particular, their weight and their cost price, it is difficult to envisage such transducers being used for ordinary purposes and large-scale commercialization.

Moreover, sound transmission is effected through a localized contact such as a contact stud which, due to its small dimensions, is suitable for exerting on the skull a substantial pressure which enables an excellent sound transmission to be achieved. However, the exertion of this localized pressure on the skull proves unpleasant, and may become traumatic after a certain period of use of the listening device. This localized pressure may also prove traumatic in the case of accidental impact on the listening device.

To overcome this disadvantage, another solution described, in particular, in the patent U.S. Pat. No. 5,889,730, has consisted in realizing an acoustic earphone comprising a piezoelectric membrane which is integrated into a case and the vibrations of which are transmitted to a conducting plate, of a material such as polyurethane, which seals one of the frontal faces of the case and forms an acoustic conductor.

According to this solution, the contact between the listening device and the skull is a surface contact, since it is constituted by a plate which conducts acoustically and, in theory, is not likely to disturb the user. In practice, however, the conductive plate undergoes deformations induced by those of the piezoelectric membrane, and is thus found to transmit this deformation against the skull at a bearing zone of limited surface area which, practically, is comparable to a localized contact. Consequently, such listening devices prove to result in the same disadvantages as those of contact-stud type listening devices. Moreover, it has also been found that the quality of the bone transmission of such listening devices is inferior to that of contact-stud type listening devices.

The present invention is intended to overcome these disadvantages, its main object being to provide a device for listening to voice and/or musical signals by means of bone transmission, the wearing of which is very comfortable for the user and which has an excellent quality of bone transmission of sound.

To this end, the invention proposes a device for listening to voice and/or musical signals by means of cranial bone transmission, comprising:

a case having an open frontal face, termed the forward frontal face, which is sealed by a flexible membrane, and an opposite frontal face, termed the rear frontal face, which consists of a rigid, hermetic wall,

a piezoelectric element having suitable dimensions in order for same to be integrated in the case, in such a way as to extend in parallel to the frontal faces of the latter,

means for supporting the piezoelectric element which are suitable for joining the periphery of the latter to the case in a solid manner, in such a way as to divide the internal volume of the said case into two hermetic chambers:

a chamber, termed the forward chamber, delimited by the flexible membrane and the piezoelectric element, and filled with an incompressible gel or fluid, and

a chamber, termed the rear chamber, delimited by the piezoelectric element and the rear frontal wall of the case, and comprising damping means suitable for compensating the stresses exerted on the piezoelectric element which result from the forces exerted on the flexible membrane during its application against a skull.

According to the invention, the listening device thus comprises a piezoelectric element which is supported at its periphery within a case in such a way that it is able to deform axially, and which delimits two hermetic chambers within the said case:

a forward chamber sealed by a flexible membrane forming a contact surface with the skull, and filled with an incompressible gel or fluid which, on the one hand, allows the forces and pressures resulting from the deformations of the piezoelectric element to be uniformly distributed over the entire surface of the flexible membrane, and, on the other hand, allows the vibrations of the piezoelectric element to be transmitted without alteration, and thus renders possible an excellent sound transmission, equivalent to that obtained with a localized contact,

and a rear chamber comprising damping means providing for compensation of the stresses exerted on the piezoelectric element.

Such a listening device is thus very pleasant to wear, due to the uniform distribution of the forces and pressures exerted on the skull over a large surface area consisting of the entire surface of the flexible membrane, making it possible to reduce, in particular, the forces and pressures exerted on the skull, compared with those exerted by the current devices.

Moreover, it makes it possible to obtain an excellent sound transmission quality, due to the fact that the incompressible gel or fluid does not alter the vibrations of the piezoelectric element, which are thus perfectly reflected on the flexible membrane.

According to a first advantageous variant of the invention, the damping means comprise resilient means bearing against the piezoelectric element and the rear frontal wall of the case, so as to form a flexible support capable of opposing a remanent deformation of this piezoelectric element.

According to this realization variant, the resilient means disposed in the rear chamber act as springs, preventing the piezoelectric element from being crushed or broken, and providing a flexibility designed to permit the vibration of this piezoelectric element.

Furthermore, advantageously, according to this variant, the resilient means consist of at least one O-ring which is disposed in an annular groove provided in the rear frontal wall of the case, and which has a diameter cross-section greater than the depth of this groove.

Moreover, advantageously, the rear chamber of the case encloses a compressible fluid.

According to a second advantageous variant of the invention, the rear chamber is filled with an incompressible gel or fluid, the damping means comprising resilient means which do not contact the piezoelectric element and are capable of deforming so as to absorb the volume variations of the rear chamber during the vibrations of the said piezoelectric element.

According to this second variant, the rear chamber is thus filled with an incompressible gel or fluid which makes it possible to achieve a pressure balance on either side of the piezoelectric element. Moreover, this rear chamber encloses resilient means capable of deforming so as to absorb the volume variations despite the non-compressibility of the fluid or gel.

Apart from the pressure balance on either side of the piezoelectric element, this variant additionally makes it possible to prevent the transmission of sound towards the portion of the case wall which delimits the rear chamber, and thus prevents the listening device functioning as a loudspeaker.

Moreover, the damping effect on the vibrations of the piezoelectric element is less than that obtained with a spring system in contact with this piezoelectric element, and the vibrations are thus less attenuated.

According to this variant, moreover, the resilient means can advantageously consist of an annular ring of a resilient material located in the rear chamber of the case.

In this case, as for the first variant, the flexible membrane is advantageously shaped so as to have a domed form, preventing contact between the case and the skull.

According to another embodiment affecting the constitution of the resilient means, the listening device according to the invention advantageously comprises an annular chamber, termed a damping chamber, provided around the forward chamber so as to be delimited by a peripheral annular zone of the flexible membrane, the said damping chamber being isolated from the said forward chamber, and communicating with the rear chamber in such a way that the peripheral zone of the flexible membrane constitutes the resilient means for absorbing volume variations of the said rear chamber.

This design of the resilient means results in the same advantages as those obtained for the above-mentioned first type of resilient means. Moreover, since the pressures exerted on the central and peripheral zones of the flexible membrane are in opposition of phase, the relative amplitude of the vibrations between these two zones is doubled.

In addition, advantageously, the flexible membrane is then shaped so as to have a central zone having a domed form suitable for delimiting the forward chamber, separated by an annular groove from a domed annular collar suitable for delimiting the damping chamber.

According to another aspect of the invention, the incompressible gel or fluid advantageously consists of water, and the piezoelectric element is covered by a covering which isolates it from the water.

Other characteristics, objects and advantages of the invention are disclosed by the detailed description which follows with reference to the appended drawings, which represent, as non-limiting examples, three preferred embodiments. In these drawings:

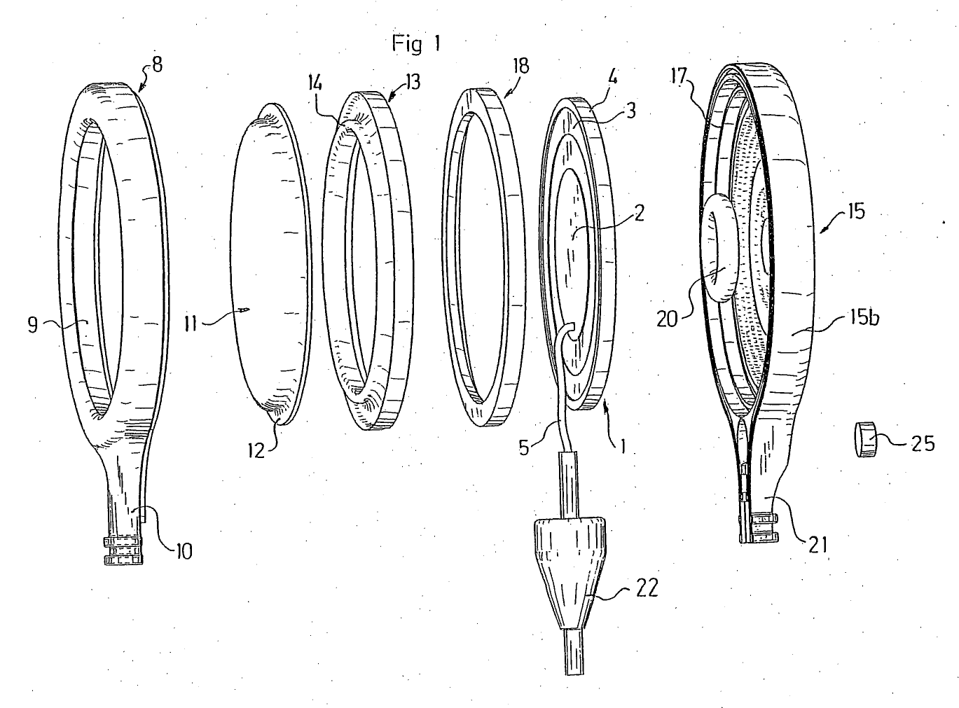

FIG. 1 is a perspective exploded view of the constituent elements of a first embodiment of the listening device according to the invention,

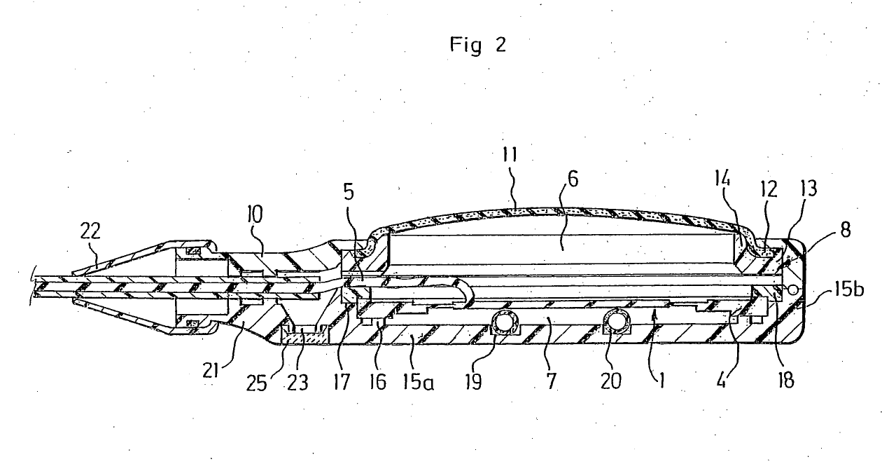

FIG. 2 is a transverse and axial longitudinal section of this listening device,

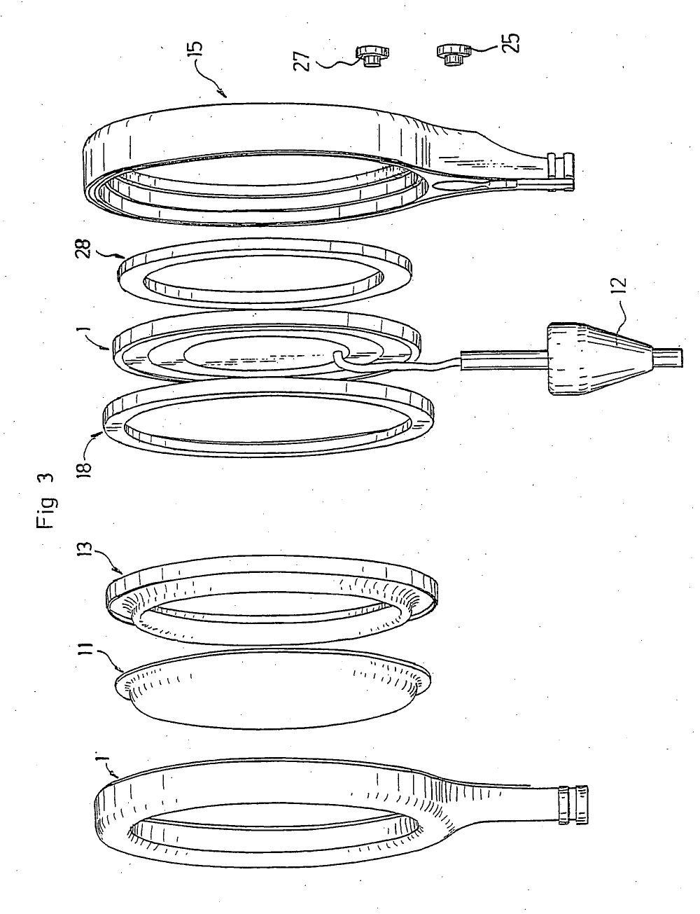

FIG. 3 is a perspective exploded view of the constituent element of a second embodiment of the listening device according to the invention,

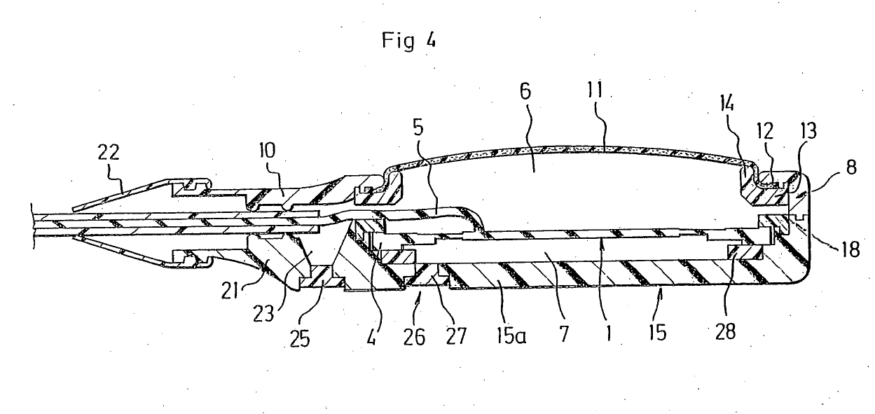

FIG. 4 is a transverse and axial longitudinal section of this listening device,

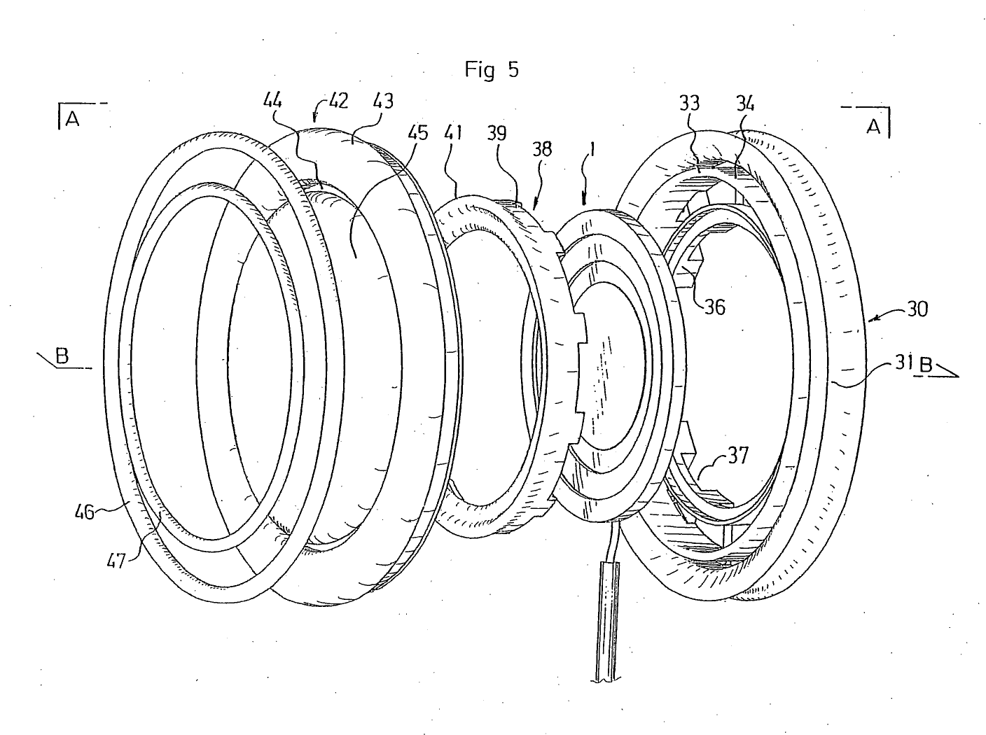

FIG. 5 is a perspective exploded view of the constituent elements of a third embodiment of the device according to the invention, and

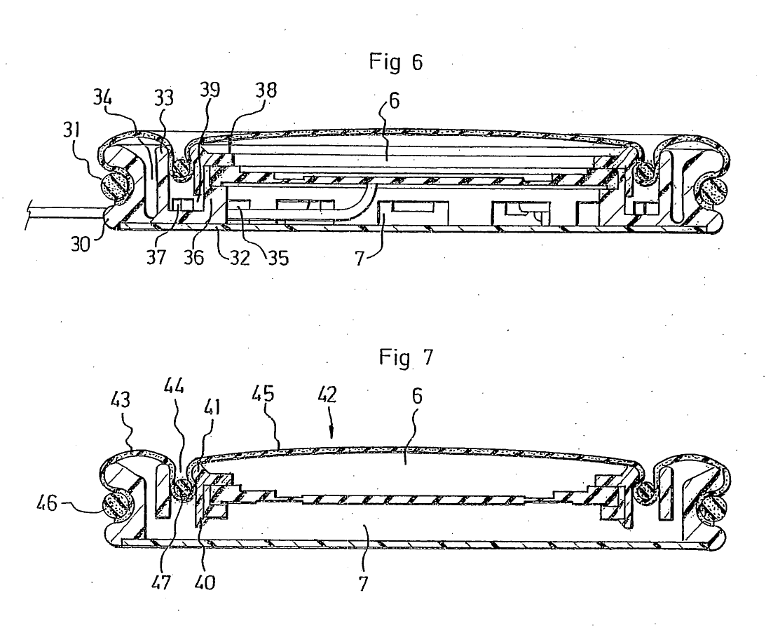

FIGS. 6 and 7 are transverse longitudinal sections according to the respective planes A and B of this listening device.

The listening devices according to the invention that are represented in the figures are designed to transmit or receive voice and/or musical signals by means of cranial bone transmission. Moreover, they are shaped so as to have a reduced form and thickness, allowing them to be worn naturally and comfortably under any known means worn on the head, without the need for special supporting means. Moreover, these listening devices are additionally designed to operate in both water and air.

Each of these devices comprises, firstly, a standard vibrating piezoelectric element 1, comprising a circular vibrating ceramic layer 2 deposited on a metal disc 3 which is bordered by an annular neutral damping ring 4. Moreover, electric connecting wires 5 are connected to this vibrating element in the usual manner; finally, this vibrating element 1 is insulated by any known covering such as latex or silicone elastomer, etc.

According to the three embodiments represented in the figures, this vibrating element 1 is integrated within a hermetic case and, within this case, delimits two hermetic chambers, termed the forward chamber 6 and the rear chamber 7.

According to the embodiment represented in FIGS. 1 and 2, this case consists of two sub-assemblies, which are designed to be fitted together at the end of the assembly process.

The first of these sub-assemblies comprises a forward flange 8, consisting of an annular ring 9, having an L-shaped cross-section, extended by a radial end piece 10 in the form of a spout.

The first sub-assembly furthermore comprises a flexible membrane 11 of a material such as latex, having a domed, circular form, bordered by a radial peripheral rim 12. The dimensions of this membrane 11 are designed such that the rim 12 comes to be supported inside the forward flange 8 in a position in which the central portion of the rim extends outside the said forward flange.

Finally, the first sub-assembly comprises an annular ring 13 having an annular projection 14 designed such that it is located in the forward flange 8 in such a way that it holds the flexible membrane 11 within the forward flange.

The second sub-assembly comprises, firstly, a rear flange 15 in the form of a cylindrical cup having dimensions designed to accommodate the vibrating element 1, and the base wall 15a of which comprises a projecting annular bead 16 for supporting the damping ring 4 of this vibrating element 1. Like the forward flange 8, this rear flange 15 also comprises a radial end piece 21 in the form of a spout, fashioned so as to be assembled with that of the said forward flange. This rear flange 15 comprises, finally, an internal shoulder 17 provided in the peripheral rim 15b of the rear flange.

The second sub-assembly additionally comprises an annular ring 18 for clamping the vibrating element 1 within the rear flange 15. The said annular ring is of an L shape, designed such that one of its wings, being a radial wing, comes to be supported on the damping ring 4 of this vibrating element 1, and such that its other axial wing comes to bear against the internal shoulder 17 of the rear flange 15.

Lastly, the rear flange 15 comprises an annular groove 19 provided in the base wall 15a of the rear flange, the said annular groove being suitable for partially accommodating an O-ring 20 of a resilient material which is made such that it can be compressed between the vibrating element 1 and this base wall 15a.

Once the various elements of the two sub-assemblies have been assembled together and these two sub-assemblies have been joined in a solid manner, and as represented in FIG. 2, these latter form a hermetic case having a sleeve, formed by the two end pieces 10, 21, onto which is clipped a sleeve 22.

Moreover and, in particular, the vibrating element 1 delimits, within this case, two hermetic chambers:

the forward chamber 6, designed to be filled with water via an opening 23 provided in the end piece 21 of the rear flange 15 and communicating with this forward chamber 6, the said opening being then sealed by a plug 25,

the rear chamber 7 in which the O-ring 20 acts as a flexible spring permitting the vibrations of the vibrating element 1.

The listening device represented in FIGS. 3 and 4 also comprises a case consisting of two quasi-identical sub-assemblies, which are identified by the same reference numerals for the similar elements.

The only difference between these two variants consists in the fact that, in the second embodiment, the annular bead 16, the O-ring 20 and the annular groove 19 of the rear flange 15 are omitted.

Instead of these latter, the rear chamber 7 is filled with water via an opening 26 provided in the base wall 15a of the rear flange 15 and sealed by a plug 27. Moreover, the damping means consist of an annular ring 28 which is located in the rear flange 15 and is of a diameter designed to support the damping ring 4 of the vibrating element 1, without contact with the metal disc 3 of the latter. This annular ring 28, made from a material such as silicone elastomer, provides for absorption of the volume variations of the rear chamber 7, and thus permits the vibrations of the vibrating element 1.

As for the case of the listening device represented in FIGS. 5 to 7, this consists principally of an annular flange 30 having, firstly, an external radial groove 31.

The rear face of this flange 30 is sealed by a rigid cylindrical plate 32 designed to delimit the rear chamber 7.

Moreover, fashioned as a single piece with this flange 30 is a collar 33 which, within the latter, delimits a peripheral annular damping chamber 34.

Fashioned within this flange 30, and still as a single piece with the latter, is a second collar 36, concentric with the first collar 33 and of a lesser diameter than this first collar 33, which is designed such that the said second collar forms a supporting seat for the vibrating element 1.

In addition, these two internal collars 33, 36 have a notched longitudinal portion 35, 37 suitable for effecting communication between the rear chamber 7 and the annular damping chamber 34.

In addition, the device according to this third embodiment comprises a ring 38, having an L-shaped cross-section, for holding the vibrating element 1 against the collar 36. In order to effect this holding, this ring comprises an annular portion 39 having a notched end portion provided with internal lugs 40 made to clip into the notches 37 of the second collar 36.

Finally, this holding ring 38 comprises an oblique frontal projection 41 designed to form a retentively shaped receiver 44 with the first collar 33 of the rear flange 30.

This third type of listening device comprises, finally, a flexible membrane 42 shaped so as to have a domed central zone 45 which is suitable for delimiting the forward chamber 6 and is separated by an annular groove from a domed annular collar 43 suitable for delimiting the damping chamber.

As represented in FIGS. 6 and 7, this flexible membrane 42 is held on the rear flange 30 by means of two O-rings:

an O-ring 46 located in the external groove 31 of the rear flange 30,

and an O-ring 47 located in the groove of this membrane which is itself inserted in the retentively shaped receiver 44 of the rear flange 30.

According to this principle, the rear chamber 7 is filled with water and communicates with the annular chamber 34 delimited by the domed annular collar 43 of the membrane 42, which thus acts as resilient means for absorbing volume variations of this rear chamber 7.

1/ A device for listening to voice and/or musical signals by means of cranial bone transmission, wherein it comprises:
a case (8, 15; 30, 32) having an open frontal face, termed the forward frontal face, sealed by a flexible membrane (11; 42), and an opposite frontal face (15a; 32), termed the rear frontal face, which consists of a rigid, hermetic wall,
a piezoelectric element (1) having suitable dimensions in order for same to be integrated in the case, in such a way as to extend in parallel to the frontal faces of the latter,
means (18; 32) for supporting the piezoelectric element (1) which are suitable for joining the periphery of the latter to the case in a solid manner, in such a way as to divide the internal volume of the said case into two hermetic chambers:
a chamber (6), termed the forward chamber, delimited by the flexible membrane (11; 42) and the piezoelectric element (1), and filled with an incompressible gel or fluid, and
a chamber (7), termed the rear chamber, delimited by the piezoelectric element (1) and the rear frontal wall (15a; 32) of the case, and comprising damping means (20; 28; 34, 43) suitable for compensating the stresses exerted on the piezoelectric element (1) which result from the forces exerted on the flexible membrane (11; 42) during its application against a skull.

2/ A listening device as claimed in claim 1, wherein the damping means comprise resilient means (20) bearing against the piezoelectric element (1) and the rear frontal wall (15a) of the case, so as to form a flexible support capable of opposing a remanent deformation of this piezoelectric element.

3/ A listening device as claimed in claim 2, wherein the resilient means consist of at least one O-ring (20) which is disposed in an annular groove (19) provided in the rear frontal wall (15a) of the case, and which has a diameter cross-section greater than the depth of this groove (19).

4/ A listening device as claimed in claim 2, wherein the rear chamber (7) of the case encloses a compressible fluid.

5/ A listening device as claimed in claim 1, wherein the rear chamber (7) is filled with an incompressible gel or fluid, the damping means comprising resilient means (28; 34, 43) which do not contact the piezoelectric element (1) and are capable of deforming so as to absorb the volume variations of the rear chamber (7) during the vibrations of the said piezoelectric element.

6/ A listening device as claimed in claim 5, wherein the resilient means consist of an annular ring (28) of a resilient material located in the rear chamber (7) of the case.

7/ A listening device as claimed in claim 2, wherein the flexible membrane (1) is shaped so as to have a domed form.

8/ A listening device as claimed in claim 5, wherein it comprises an annular chamber (34), termed a damping chamber, provided around the forward chamber (6) so as to be delimited by a peripheral annular zone (43) of the flexible membrane (42), the said damping chamber being isolated from the said forward chamber, and communicating with the rear chamber (7) in such a way that the peripheral zone (43) of the flexible membrane (42) constitutes the resilient means for absorbing volume variations of the said rear chamber.

9/ A listening device as claimed in claim 8, wherein the flexible membrane (42) is shaped so as to have a central zone (45) having a domed form suitable for delimiting the forward chamber (6), separated by an annular groove from a domed annular collar (43) suitable for delimiting the damping chamber (34).

10/ A listening device as claimed in claim 1, wherein the incompressible gel or fluid consists of water, and wherein the piezoelectric element (1) is covered by a covering which isolates it from the water.

11/ A listening device as claimed in claim 3, wherein the rear chamber (7) of the case encloses a compressible fluid.

12/ A listening device as claimed in claim 5, wherein the flexible membrane (1) is shaped so as to have a domed form.
